(19) United States
(12) Patent Application Publication
(10) Pub. No.: US 2007/0241588 A1
(43) Pub. Date: Oct. 18, 2007

(54) Reinforcement piece for a bodywork element

(75) Inventors: Jerome Grando, Vertrieu (FR); Francis Cordebar, Lyon (FR)

Correspondence Address: OLIFF & BERRIDGE, PLC, P.O. BOX 19928, ALEXANDRIA, VA, 22320, US

(73) Assignee: COMPAGNIE PLASTIC OMNIUM, Lyon (FR)

(21) Appl. No.: 11/404,784

(22) Filed: Apr. 17, 2006

(30) Foreign Application Priority Data
Apr. 15, 2006 (FR) 0503799

(51) Int. Cl. B60J 7/00

(52) U.S. Cl. 296/204

(57) ABSTRACT

A reinforcement piece (10′) for a motor vehicle bodywork element made of plastics material, including an empty space (20) for receiving electrical equipment (22), and means (16) for securing a metal plate (21), preferably by snap-fastening, said means being arranged on the reinforcement piece in such a manner as to hold said plate beneath the empty space.

The present invention relates to a reinforcement piece for a motor vehicle bodywork element.

In the front bumpers of motor vehicles, it is already known to use shield reinforcement pieces, in particular central reinforcement, that serve to prevent blistering and to give an impression of better quality and solidity to the user.

A global positioning system (GPS) antenna that needs to be mounted on a metal portion of a vehicle, e.g. on its engine, is also known. The GPS antenna is integrated in the vehicle during a specific assembly operation.

That operation of assembling a GPS antenna, which is optional, represents a non-negligible cost, requiring a special assembly station to be created on the main assembly line, and requiring associated labor to be used.

A particular object of the invention is to remedy those drawbacks by providing a reinforcement piece capable of receiving electrical equipment such as a GPS antenna, and enabling it to be integrated in the front of the vehicle without it being necessary to fit it separately to the vehicle.

To this end, the invention provides a reinforcement piece for a motor vehicle bodywork element made of plastics material, the reinforcement piece being characterized in that it includes an empty space for receiving an electrical equipment, and means for securing a metal plate, preferably by snap-fastening, said means being arranged on the reinforcement piece in such a manner as to hold said plate beneath the empty space.

Thus, the electrical equipment can be mounted in advance in the empty space and then fitted on the vehicle together with its support which can be constituted by the reinforcement piece, thereby avoiding the need to provide a special station on the main assembly line. The empty space is not always formed in the support to which the equipment is secured: it may be secured to the reinforcement piece, e.g. directly on the metal plate, or else on the bodywork element, above said plate.

The metal plate combines two functions: firstly it acts as a ground plane enabling the electrical equipment to operate, which equipment is normally designed to be suitable for fastening on a metal portion. Secondly, it contributes its own rigidity to the reinforcement piece, which, because of its empty space, presents rigidity that is less than that of a reinforcement piece not including such empty space. Thus, the metal plate compensates for the reduced rigidity of the reinforcement piece, which thus conserves the same effectiveness against blistering.

The present invention also provides a solution avoiding any need for a metal plate always to be included in the reinforcement piece. Thus, in a particular embodiment, the reinforcement piece includes a breakable support member situated in the vicinity of the empty space. The support member can either be broken, in which case a metal plate is fitted on the reinforcement piece, or else it can be conserved, in which case no plate is secured.

This embodiment presents the advantage that the rigidity of the reinforcement piece is not increased excessively by the combined presence of the plate and of the support member, thereby protecting pedestrians in the event of an impact. On the assumption that the bodywork element is a front bumper shield, pedestrians could be severely injured, particularly at the hip, if the shield were to present excess rigidity.

In other words, the support member serves to compensate for the lack of rigidity due to the absence of the plate, but it can be eliminated so as to avoid the rigidity of the reinforcement piece being increased excessively in the event of the plate being present.

An advantage of said reinforcement piece with a breakable support member is that a single model of the reinforcement piece can be manufactured without paying any attention to the optional characteristics it might present—i.e. with or without a plate—. This enables manufacturing costs to be reduced, since only one mold is required, and it enables stock management of reinforcement pieces to be simplified.

The support member must thus be broken for each vehicle in which electrical equipment is integrated under the bodywork element.

Thus, in a particular embodiment, the support member is shaped in such a manner as to impede putting the electrical equipment into place in the empty space in the reinforcement piece, and in such a manner that breaking said support member releases access to the empty space provided for the electrical equipment.

Thus, the electrical equipment cannot be put into place so long as the support member has not been broken, thereby constituting means that are effective in guaranteeing the safety of the reinforcement piece.

In addition, in a particular embodiment, the support member is dimensioned so as to be breakable manually. This also makes it possible to reduce any additional costs that might be induced by including electrical equipment in the bodywork element, since no additional tool is required for performing this operation.

Optionally the support member is made breakable by means of a transverse notch formed therein during molding.

Making it easy to break avoids any need to provide additional steps on the assembly line.

Optionally, the electrical equipment is a GPS antenna.

Optionally, the bodywork element is a front bumper shield.

The invention can be better understood on reading the following description given purely by way of example and made with reference to the accompanying drawings, in which:

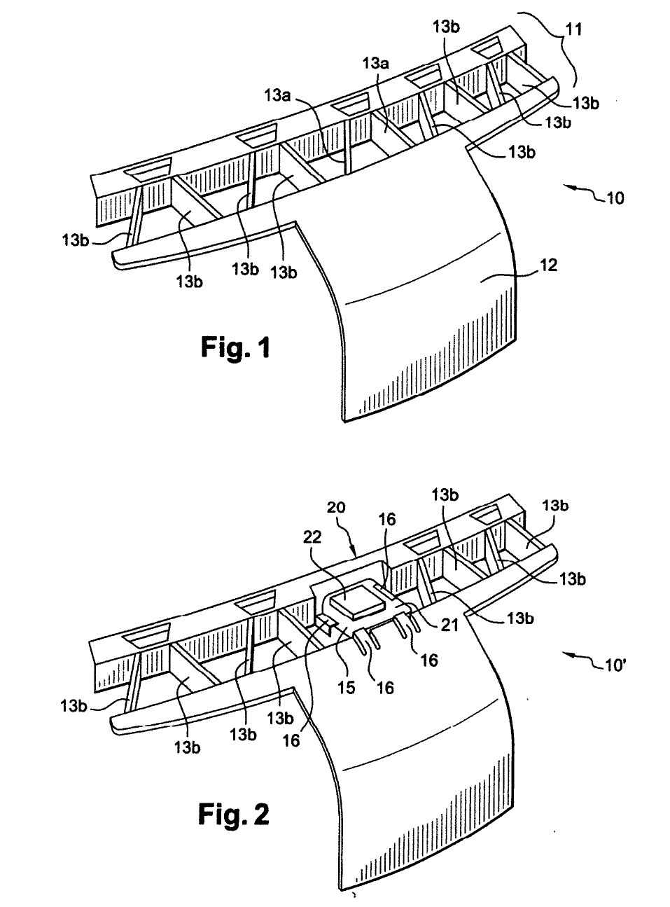

FIG. 1 is an outside view of conventional central reinforcement for a front shield;

FIG. 2 is an outside view of central reinforcement for a front shield constituting an embodiment of the invention and including electrical equipment;

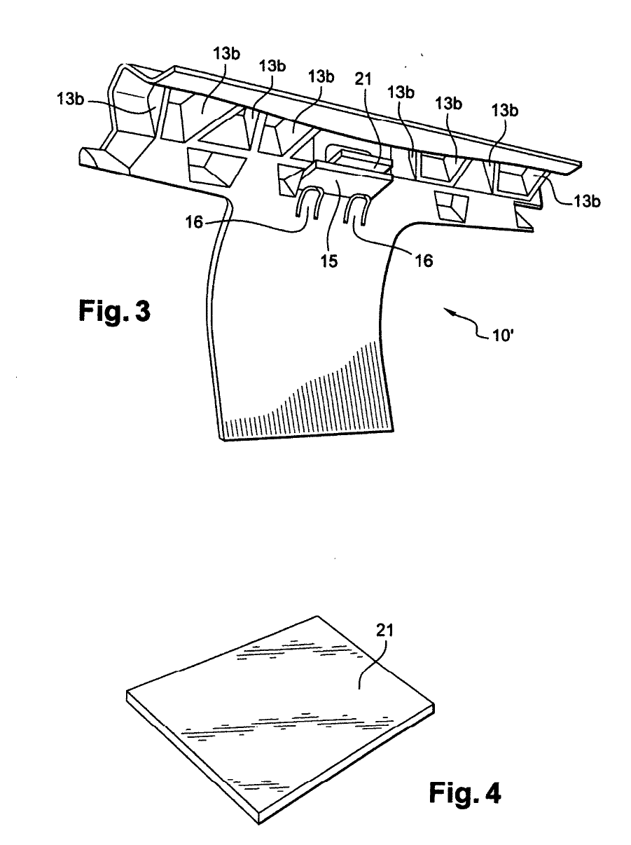

FIG. 3 is an inside view of the central reinforcement of FIG. 2;

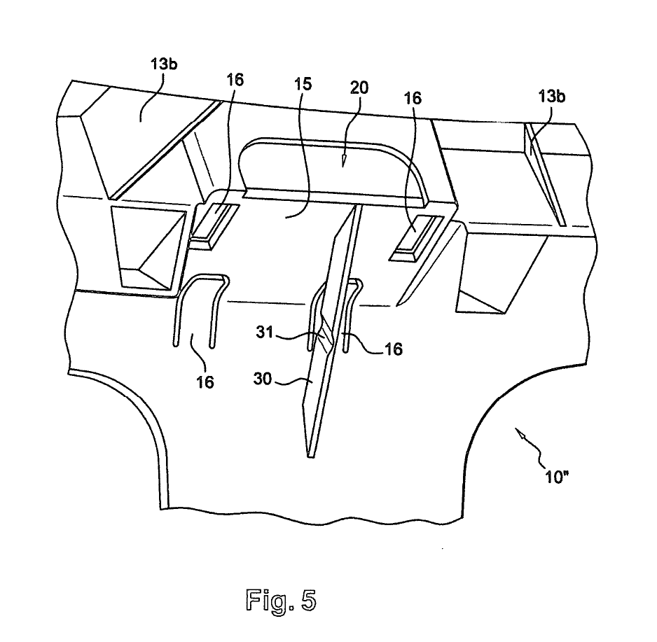

FIG. 4 shows a metal plate suitable for use in the invention; and

FIG. 5 is an enlargement of the inside of central reinforcement for a front shield constituting another embodiment, in which the electrical equipment is not integrated in the vehicle.

In FIG. 1, there can be seen central reinforcement 10 for a motor vehicle shield. The central reinforcement 10, which constitutes a reinforcement piece in the meaning of the invention, has a bottom portion 12 and a top portion 11 for supporting a bumper skin (not shown in the drawings). The top portion 11 of this central reinforcement 10 has reinforcing ribs 13a, 13b that serve to prevent the skin from blistering.

Blistering is when the bumper skin is pushed in or depressed as a result of pressure being applied to the skin, e.g. by the finger of a user.

FIG. 2 shows the central reinforcement 10′ of the same type but modified in accordance with the invention. It still has ribs 13b. However the central ribs 13a of FIG. 1 are missing: they leave an empty space 20 suitable for supporting a metal plate 21, itself serving as a support, and as a ground plate for a GPS antenna 22 constituting electrical equipment in the meaning of the invention.

The metal plate 21 is secured to the reinforcement 10′ in the bottom 15 of the empty space 20 by fastener means, which means are constituted in the example described by four snap-fastening tabs 16, but in other embodiments of the invention could be screw-fastener means, adhesive means, etc.

The inertia of the metal plate 21 confers rigidity to the central reinforcement 10′ similar to that of the central reinforcement 10 in spite of the absence of the central rib 13a.

No support member 30 can be seen in this figure.

FIG. 5 shows a support member 30 in the form of a prop integrally molded with the reinforcement. The support member and the bottom 15 form a bracket that presents sufficient rigidity to withstand a force exerted by a user on the shield (not shown).

Adding the support member 30 thus enables the central reinforcement 10″ to perform its anti-blistering function, even when the metal plate 21 is not secured to the reinforcement 10″.

The support member 30 is breakable for circumstances in which the metal plate 21 is present. Thus, the rigidity of the reinforcement 10″ is never excessive, which would be dangerous in the event of the vehicle impacting against a pedestrian.

To this end, a transverse notch 31 is formed in the support member 30. This notch weakens the member 30 when it is stressed in bending or flexing, but weakens it less in compression, as applies when a force is exerted on the bumper skin.

Consequently, although it is possible to break the support member manually during assembly by flexing it, a manual force exerted by a user on the bumper skin that acts on the support member 30 in compression is not sufficient to cause it to break.

The invention thus enables electrical equipment to be integrated in optional manner in a motor vehicle front shield, which shield can be mass-produced using a single set of molds, while enabling the front shield to perform an anti-blistering function effectively and to provide the vehicle and its environment with safety, e.g. in the event of an impact.

Finally, it should be observed that the embodiment described in the example above is not limiting and the invention can be implemented in a variety of ways.

1. A reinforcement piece (10′, 10″) for a motor vehicle bodywork element made of plastics material, wherein the reinforcement piece includes an empty space (20) for receiving electrical equipment (22), and means (16) for securing a metal plate (21), preferably by snap-fastening, said means being arranged on the reinforcement piece (10′, 10″) in such a manner as to hold said plate (21) beneath the empty space (20).

2. A reinforcement piece according to claim 1, including a breakable support member (30) situated in the vicinity of the empty space (20).

3. A reinforcement piece according to claim 2, the breakable support member (30) being shaped in such a manner as to impede putting the electrical equipment (22) into place in the empty space (20) of the reinforcement piece (10′, 10″), and in such a manner that breaking said support member (30) releases the empty space (20) provided for the electrical equipment (22).

4. A reinforcement piece according to claim 2, wherein the support member (30) is dimensioned in such a manner as to be breakable manually.

5. A reinforcement piece according to claim 2, in which the support member (30) includes a transverse notch (31) formed at the time of molding.

6. A reinforcement piece according to claim 1, in which the electrical equipment (22) is a GPS antenna.
